(19) United States
(12) Patent Application Publication
(10) Pub. No.: US 2025/0286424 A1
(43) Pub. Date: Sep. 11, 2025

(54) STATOR OF AN ELECTRIC MACHINE

(71) Applicant: Robert Bosch GmbH, Stuttgart (DE)

(72) Inventors: Jannik Stammler, Stuttgart (DE); Daniel Kuehbacher, Stuttgart (DE); Felix Bensing, Stuttgart (DE); Christian Bonk, Laatzen (DE); Johannes Riedl, Bergheim (DE)

(21) Appl. No.: 18/858,485

(22) PCT Filed: Mar. 20, 2023
(86) PCT No.: PCT/EP2023/057040

§ 371 Date: Oct. 21, 2024

(30) Foreign Application Priority Data
Apr. 21, 2022 (DE) 10 2022 203 892.4

(51) Int. Cl. H02K 3/52; H02K 3/48

(52) U.S. Cl. CPC H02K 3/522; H02K 3/48

(57) ABSTRACT

A stator (1) of an electric machine (2), comprising a stator body (3) with a stator axis (3.1) and an electrical stator winding (4), wherein stator teeth (5) are formed on the stator body (3) and stator grooves (6) are formed between the stator teeth (5), wherein the stator body (3) comprises stator discs (7), in particular sheet metal blades for forming a laminated core and/or cover discs, wherein the stator winding (4) comprises a plurality of interconnected conductor elements (8), wherein pairs (9) of conductor ends (8e) of multiple of conductor elements (8) are electrically contacted in the stator grooves (6) at a contact point (10) in the respective stator groove (6) to form contact connections (11), in that contact surfaces (12) of the pairs (9) of conductor ends (8e) are contacted by means of contact forces (13),
characterized in that the contact connections (11), in particular the contact forces (13) for forming the contact connections (11), are generated by twisting at least one of the stator discs (7) of the stator body (3), in particular individual stator discs (7) or one or more groups (14) of stator discs (7).

### BACKGROUND

The invention proceeds from a stator of an electric machine.

A stator of an electric machine from EP3138184 B1 is already known, comprising a stator body with a stator axis and an electrical stator winding, wherein stator teeth are formed on the stator body and stator grooves are formed between the stator teeth, wherein the stator body comprises stator discs for forming a laminated core, wherein the stator winding comprises a plurality of interconnected conductor elements, wherein in the stator grooves, pairs of conductor ends of multiple conductor elements are electrically contacted at a contact point in the respective stator groove for forming contact connections, in that contact surfaces of the pairs of conductor ends are contacted by means of contact forces. The contact forces are generated by wedging the conductor ends of the respective conductor elements in the stator grooves. Due to the cumulative tolerances for each contact connection, it is difficult to produce high quality contact connections in a reproducible manner.

### SUMMARY

In contrast, the stator of an electric machine according to the invention has the advantage that the manufacturing of the stator winding is improved and/or simplified because the contact connections, in particular the contact forces for forming the contact connections, are formed by the twisting of at least one of the stator discs of the stator body, in particular of individual stator discs or of one or more groups of stator discs. The stator winding according to the invention can therefore be produced without a bonded connection, for example without welding the conductor elements. In addition, the stator winding can be formed from pre-formed conductor elements and can be assembled so that interlocking of the conductor elements can be omitted in manufacturing the stator winding.

It is particularly advantageous if the twisted stator discs lie in the axial region of the respective contact point and press with peripheral flanks at least indirectly against the contact surfaces to cause the contact surfaces of the respective contact connection to contact one another. In this way, the stator discs generate clamping contact forces for establishing the contact connections.

It is furthermore advantageous if the conductor ends of at least one of the contact connections are connected in a positive-locking manner. In this way, sufficiently large contact areas can be formed for the contact connections.

According to a first exemplary embodiment, it is very advantageous for one of the two conductor ends of the respective contact connection to have a recess, in particular a notch, and for the other conductor end of the contact connection to have a protruding projection, in particular a square pin, wherein the recess and projection of the respective contact connection have corresponding contact surfaces. In this way, a very simple and easy-to-mount plug connection is achieved as a contact connection. The square projection of the respective conductor end of the respective pair of conductors can have parallel or oblique contact surfaces.

It is also advantageous if the recess of the one conductor end of the respective contact connection in the axial direction with respect to the stator axis is respectively longer than the projection of the other conductor end of the respective contact connection, whereby a compensation gap is respectively formed. In this way, tolerances that have an impact on the respective contact connection can be balanced out, for example a width of the stator groove, a width of the conductor cross-section of the conductor element, a thickness of a enamel insulation of the conductor elements.

Furthermore, is advantageous if, according to a second exemplary embodiment, both conductor ends of the respective contact connection each have a protrusion or a respective recess and that an additional connecting element is provided as the third contact partner of the respective contact connection, connecting the two conductor ends of the respective contact connection, in particular by enclosing the two projections or by placing them in the two recesses of the two conductor ends, and which is in particular sleeve-shaped or pin-shaped. In this way, large contact areas can be achieved. In addition, a plastic deformation of the three contact partners can be produced during the manufacturing of the contact connections, whereby the clamping contact forces to be applied by the stator discs can be lower.

Moreover, it is advantageous if an adhesive bonding agent, in particular a soft solder or a coating comprising silver and/or nickel, is provided between the contact partners of the respective contact connection, in particular in the compensation gap or on the additional connecting element. In this way, in addition to the positive-locking and frictional connections, an adhesive bond can be achieved between the conductor ends of the respective contact connection, which can reduce the contact transition resistance between the conductor ends and improve the electrical conduction between the conductor ends. The material bond is formed by bringing the stator to a temperature above the softening temperature of the bonding agent during production.

It is advantageous if the contact surfaces of the respective contact connection are configured in parallel or quasi-parallel with tooth flanks of the respective stator groove. In this way, the contact connection can be implemented as a plug-in connection. The contact surfaces of the respective contact connections are pushed against each other after axially mating the pairs of conductor ends by means of the twisted stator discs.

In addition, it is advantageous if an additional element for generating an additional contact force is provided in the respective stator groove, which is in particular a spring element or a crimping element. In this way, it is ensured that the contact forces of the respective contact connection are maintained overall continuously and at a sufficiently high level over the life of the stator.

It is furthermore advantageous if a groove insulation is provided in the area of the contact points between the respective stator groove and the conductor elements lying in the stator groove, which is in particular sleeve-shaped or cuff-shaped. This prevents the stator discs twisted to form the contact connection from damaging the insulation of the conductor elements due to the contact forces they exert. Thus, this therefore ensures that the stator body remains electrically isolated from the stator winding.

Advantageously, the conductor elements of the stator winding are made of flat or rectangular wire and each have a rectangular conductor cross section.

It is further advantageous if the twisted stator discs, in particular the sheet metal blades, are fixed in the stator body, in particular by welding the twisted stator discs to adjacent stator discs or by a press fit between the stator body and a stator housing, for example, that encloses the stator. In this way, it is ensured that the contact forces can be continuously maintained.

According to an advantageous embodiment, it is provided that the stator winding is divided in axial direction with respect to the stator axis into at least two winding parts, wherein each winding part is formed from a plurality of conductor elements, wherein conductor ends of the one winding part are contacted with one of the conductor ends of another winding part, in particular in a friction-locking manner by twisting the particular stator discs. Thus, by twisting the stator discs according to the invention, many contact connections are made within the stator grooves in one step. The winding parts of the stator winding can in this way be assembled in the axial direction and electrically connected to the stator winding by twisting the stator discs according to the invention, forming a plurality of contact connections according to the invention. This can be done in particular without adhesive bonding, for example without welding, of the conductor elements of the winding parts.

The invention also relates to an electrical machine with a stator according to the invention.

### BRIEF DESCRIPTION OF THE DRAWINGS

An exemplary embodiment of the invention is shown in simplified form in the drawing and explained in more detail in the following description.

FIG. 1 shows a stator of an electric machine with stator discs twisted according to the present invention for the frictionally locking electrical contacting of pairs of conductor ends within the stator grooves of the stator,

FIG. 2 a sectional view of a single stator groove of the stator according to FIG. 1,

FIG. 3 a view of a detail X according to FIG. 2 in accordance with a first exemplary embodiment,

FIG. 4 a view of the detail X of FIG. 2 according to a second exemplary embodiment,

FIG. 5 a view of the detail X pursuant to FIG. 2 according to a third exemplary embodiment,

FIG. 6 a pair of conductor ends according to the invention for forming one of the contact connections according to a first exemplary embodiment,

FIG. 7 a pair of conductor ends according to the present invention for forming one of the contact connections according to a second exemplary embodiment,

FIG. 8 a pair of conductor ends according to the invention for forming one of the contact connections according to a third design of the first exemplary embodiment, and

FIG. 9 a pair of conductor ends according to the invention with an additional element for generating an additional contact force.

### DETAILED DESCRIPTION

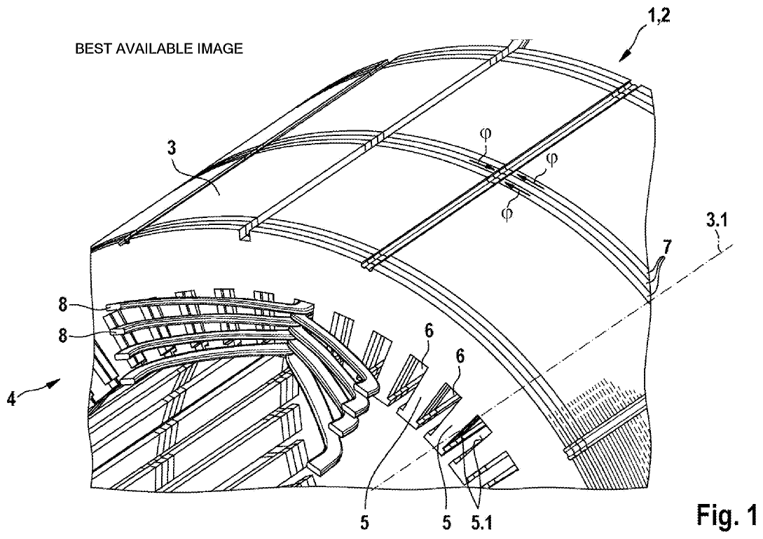

FIG. 1 shows a partial view of a stator of an electric machine with stator discs twisted according to the present invention for the frictionally locking electrical contacting of pairs of conductor ends within the stator grooves of the stator.

The stator 1 of an electric machine 2 according to the invention comprises a stator body 3 and an electrical stator winding 4. Stator teeth 5 and between the stator teeth 5 stator grooves 6 are formed on the stator body 3. The stator body 3 comprises stator discs 7, in particular sheet metal blades made of electrical sheet for forming a laminated core and/or other discs, for example cover discs.

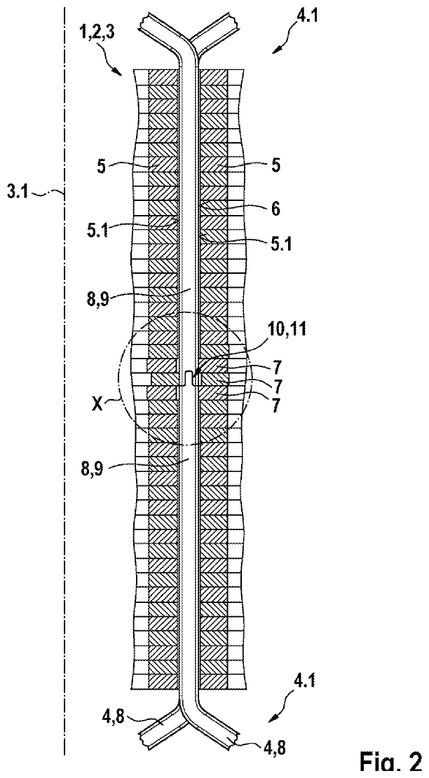

To provide a better illustration, the stator discs 7 shown in FIG. 1 and FIG. 2 are shown comparatively thick and can each also comprise a group of stator discs, in particular sheet metal blades.

The stator winding 4 comprises a plurality of interconnected conductor elements 8.

In the stator grooves 6, pairs 9 of conductor ends 82 multiple conductor elements 8 are electrically contacted at a contact point 10 in the respective stator groove 6 for forming contact connections 11 by contacting contact surfaces 12 of the pairs 9 of conductor ends 8e by means of contact forces.

Either a single electrical conductor per stator groove 6 or a conductor bundle comprising multiple electrical conductors can be provided in each of the stator grooves 6 after formation of the contact connections 11. As shown in FIG. 1, the conductors of the conductor bundle lie radially over one another with respect to a stator axis 3.1.

The conductor elements 8 of the stator winding 4 are made of, for example, flat or rectangular wire and each have a rectangular conductor cross section. Further, the conductor elements 8 of the stator winding 4 can each have an enamel insulation 8i, for example.

To illustrate the invention, FIG. 1 shows the stator winding 4 in only one of the stator grooves 5. The stator winding 4 forms a winding overhang 4.1 on the two front sides of the stator body 3.

FIG. 2 shows a sectional view of a single stator groove 6 of the stator 1 according to FIG. 1.

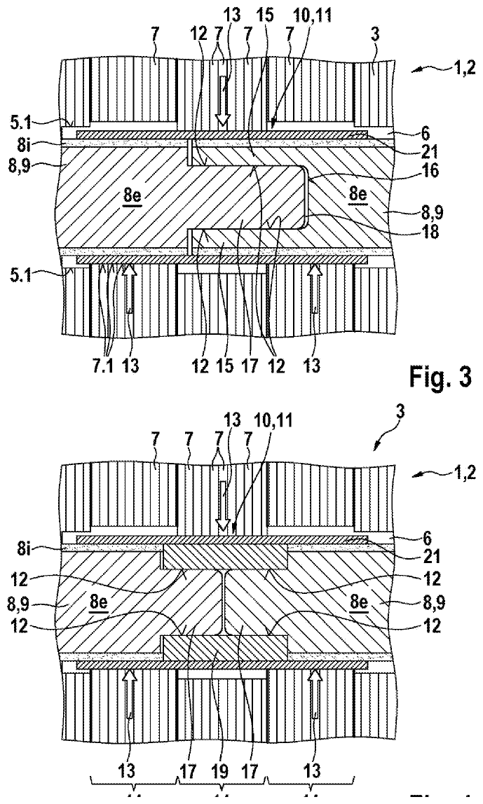

FIG. 3 shows a view of a detail X according to FIG. 2 in accordance with a first exemplary embodiment.

According to the invention, it is provided that the contact connections 11, in particular the contact forces for forming the contact connections 11, are generated by twisting at least one of the stator discs 7 of the stator body 3, in particular individual stator discs 7 or one or more groups of stator discs 7. The contact connections 11 can be generated by twisting stator discs 7 or groups 14 of stator discs 7 in opposite directions from one another, as shown in FIG. 3 to FIG. 5. The twisting of the stator discs 7 is respectively carried out by a rotation angle f about the stator axis 3.1.

The twisted stator discs 7 are fixed in the stator body 3, in particular by welding the twisted stator discs 7 to adjacent stator discs 7 or by a press fit between the stator body 3 and a stator housing surrounding the stator body 3.

The stator winding 4 can be divided into at least two winding parts in the axial direction with respect to the stator axis 3.1 in a manner not shown, wherein each winding part is formed from a plurality of conductor elements 8. According to the present invention, each of the conductor ends 8e of the one winding part can be contacted with one of the conductor ends 8e of another winding part, in particular by twisting of the particular stator discs 7 to form a frictional connection, while forming one of the contact connections 11.

The twisted stator discs 7 lie in the axial region of the respective contact point 10 with respect to the stator axis 3.1 and at least indirectly push against the contact surfaces 12 with tooth flanks 7.1 in the circumferential direction with respect to the stator axis 3.1, causing the contact surfaces 12 of the respective contact connection 11 to contact one another.

The contact points 10 of the pairs of conductor ends 8e lying in the same stator groove 6 and their contact connections 11 can lie in the respective stator groove 6 at the same or at different axial positions.

The conductor ends 8e of at least one of the contact connections 11 are connected in pairs in a frictionally locking manner.

The contact surfaces 12 of the respective contact connection 11 are configured in parallel or quasi-parallel to tooth flanks 4.1 of the respective stator groove 4. The contact surfaces 12 of the respective contact connections 11 are pressed against each other after axially connecting the pairs of conductor ends 8e by means of the twisted stator discs 7.

According to the first exemplary embodiment, one of the two conductor ends 8e of the respective contact connection 11 comprises a recess 16, in particular a notch, and the other conductor end 8e of the contact connection 11 comprises a protrusion 17, in particular a square pin, in the recess 16 of the one conductor end 8e. The recess 16 and the protrusion 17 of the respective contact connection 11 have corresponding contact surfaces 12. The recess 16 of the one conductor end 8e of the respective contact connection 11 can be configured in the axial direction with respect to the stator axis 3.1 so that it is longer than the projection 17 of the other conductor end 8e of the respective contact connection 11, whereby a compensation gap 18 is formed in the contact connection in question.

In the area of the contact points 10, groove insulation 21 can be provided between the respective stator groove 6 and the conductor elements 8 lying in the respective stator groove 6, which is in particular sleeve-shaped or cuff-shaped.

FIG. 4 shows a view of the detail X of FIG. 2 in accordance with a second exemplary embodiment.

According to the second exemplary embodiment, both conductor ends 8e of the respective contact connection 11 each have a protrusion 17. In addition, an additional connection element 19 is provided as the third contact partner of the respective contact connection 11, which connects the two conductor ends 8e of the respective contact connection 11 to each other, in particular by enclosing the two protrusions 17 in sleeve-like fashion.

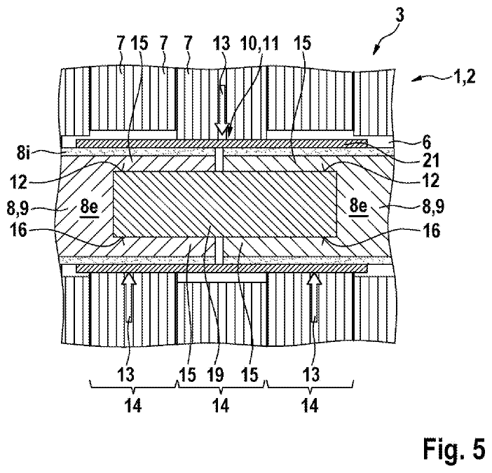

FIG. 5 shows a view of the detail X pursuant to FIG. 2 according to a third exemplary embodiment.

According to the third exemplary embodiment, each of the conductor ends 8e of the respective contact connection 11 have a recess 16. In addition, an additional connection element 19 is provided as the third contact partner of the respective contact connection 11, which connects the two conductor ends 8e of the respective contact connection 11 to each other, in particular by arranging or projecting the connecting element 19 into the two recesses 16 of the two conductor ends 8e. According to the third exemplary embodiment, the additional connecting element 19 is configured in a pin shape.

An adhesive bonding agent, in particular a soft solder or a coating containing silver and/or nickel, can be provided between the contact partners 8e, 19 of the respective contact connection 11, in particular in the compensation gap 18 or on the additional connection element 19, in order to be able to establish a bonded connection in addition to the frictional and force-locking connection according to the invention.

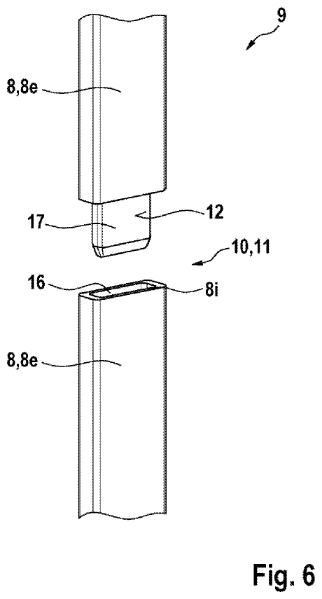

FIG. 6 shows a pair of conductor ends according to the present invention for forming one of the contact connections according to a first exemplary embodiment.

According to the first embodiment, the projection 17 of the one conductor end 8e, which is designed as a square, offset pin, is completely enclosed by the other conductor end 8e after being inserted into the recess 16 of the other conductor end 8e and is thus no longer visible.

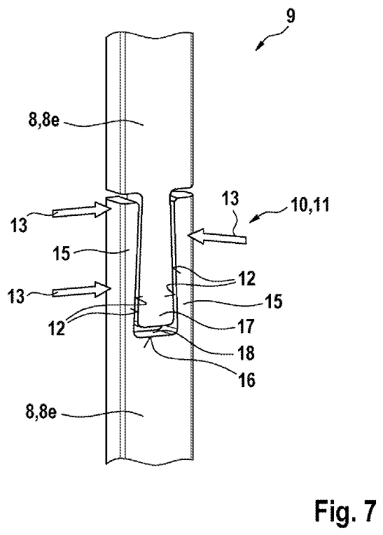

FIG. 7 shows a pair of conductor ends according to the present invention for forming one of the contact connections according to a second design of the first exemplary embodiment.

According to the second embodiment, the recess 16 of the one conductor end 8e is designed as a notch, which is formed continuously in the direction of a height or width of the conductor end 8e. For example, the recess 16 forms a fork-shaped conductor end 8e. The projection 17 of the other conductor end 8e, which is designed as a square pin, is inserted between the tines 15 of the fork-shaped conductor end 8e to produce a pin-shaped contact connection or a contact connection in which one element is inserted into another to form a corner (a design similar to that used in wood connections or wood beam joints) 11. The notch 16 and the pin 17 can correspondingly be wedge-shaped so that the contact connection 11 can absorb an axial pull-out force to prevent unwanted separation of the contact connection 11 after the contact forces are generated by twisting the stator discs 7.

Alternatively to the pin or corner-forming contact design, the respective pair of conductor ends can also form a so-called straight sheet, which is similar to a design used in wood connections or wooden beam joints.

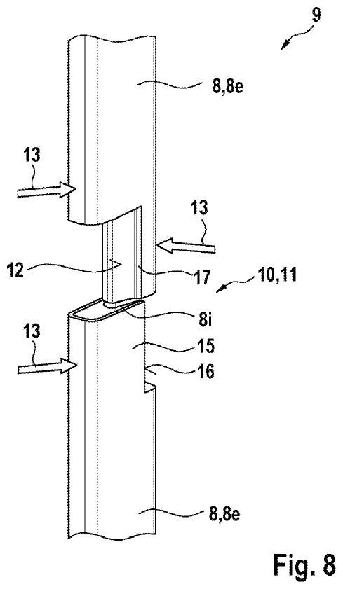

FIG. 8 shows a pair of conductor ends according to the present invention for forming one of the contact connections according to a third design of the first exemplary embodiment

According to the second design, the contact connection is arranged such that the pins form the contact lock.

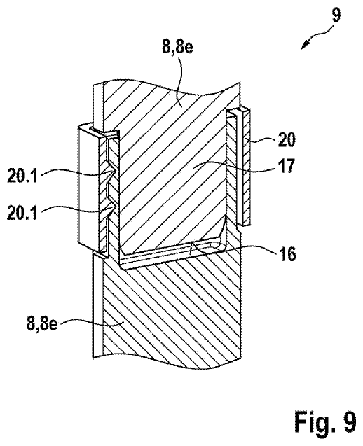

FIG. 9 shows a pair of conductor ends according to the present invention with an additional element for generating an additional contact force.

In the stator grooves 6, in the area of the contact points 10, a respective additional element 20 can be provided to generate an additional contact force that presses together the contact surfaces 12, which is in particular a spring element or a crimping element and is designed, for example, in a sleeve-shaped or a clip-shaped manner.

For example, the additional element 20 can bite into the material of the conductor ends 8e with tips 20.1.

1. A stator (1) of an electric machine (2), comprising a stator body (3) with a stator axis (3.1) and an electrical stator winding (4), wherein stator teeth (5) are formed on the stator body (3) and between the stator teeth (5) are stator grooves (6), wherein the stator body (3) comprises stator discs (7), wherein the stator winding (4) comprises a plurality of interconnected conductor elements (8), wherein in the stator grooves (6), pairs (9) of conductor ends (8e) of multiple conductor elements (8) are electrically contacted at a contact point (10) in the respective stator groove (6) for forming contact connections (11), wherein contact surfaces (12) of the pairs (9) of conductor ends (8e) are contacted by contact forces (13),
wherein
the contact connections (11) are generated by twisting at least one of the stator discs (7) of the stator body (3).

2. The stator according to claim 1, wherein the twisted stator discs (7) lie in an axial area of the respective contact point (10) and at least indirectly push with tooth flanks (7.1) in a circumferential direction against the contact surfaces (12), causing the contact surfaces (12) of the respective contact connection (11) to contact one another.

3. The stator according to claim 1, wherein the conductor ends (8e) of at least one of the contact connections (11) are connected in a positive-locking manner.

4. The stator according to claim 1, wherein in that one of the two conductor ends (8e) of the respective contact connection (11) comprises a recess (16) and the other conductor end (8e) of the contact connection (11) has a protrusion (17) projecting into the recess (16) of the one conductor end (8e), wherein the recess (16) and the protrusion (17) of the respective contact connection (11) have corresponding contact surfaces (12).

5. The stator according to claim 4, wherein the recess (16) of the one conductor end (8e) of the respective contact connection (11) is respectively longer in the axial direction with respect to the stator axis (3.1) than the projection (17) of the other conductor end (8e) of the respective contact connection (11), whereby a compensation gap (18) is respectively formed.

6. The stator according to claim 1, wherein that two conductor ends (8e) of the respective contact connection (11) each comprise a protrusion (17) or a recess (16) and that an additional connection element (19) is provided as a third contact partner of the respective contact connection (11), connecting the two conductor ends (8e) of the respective contact connection (11) together.

7. The stator according to claim 1, wherein an adhesive bonding agent is provided between the contact partners (8e, 19) of the respective contact connection (11).

8. The stator according to claim 1, wherein the contact surfaces (12) of the respective contact connection (11) are configured parallel or quasi-parallel to tooth flanks (5.1) of the respective stator groove (6).

9. The stator according to claim 1, wherein in the respective stator groove (6) an additional element (20) is provided for generating an additional contact force.

10. The stator according to claim 1, wherein a groove insulation (21) is provided in an area of the contact points (10) between the respective stator groove (6) and the conductor elements (8) lying in the stator groove (6).

11. The stator according to claim 1, wherein the conductor elements (8) of the stator winding (4) are made of flat or rectangular wire and each have a rectangular conductor cross section.

12. The stator according to claim 1, wherein the twisted stator discs (7) are fixed in the stator body (3).

13. The stator according to claim 1, wherein the stator winding (4) is divided into at least two winding parts in an axial direction with respect to the stator axis (3.1), wherein each winding part is formed from a plurality of conductor elements (8), wherein each of the conductor ends (8e) of the one winding part are respectively contacted with one of the conductor ends (8e) of another winding part, forming one of the contact connections (11).

14. An electric machine (2) with a stator (1) according to claim 1.

15. The stator according to claim 1, wherein the contact discs are sheet metal blades for forming a laminated core and/or cover discs.

16. The stator according to claim 1, wherein the contact connections (11) are generated by twisting individual stator discs (7) or one or more groups (14) of stator discs (7).

17. The stator according to claim 4, wherein the recess (16) is a notch and the protrusion (17) is a square pin.

18. The stator according to claim 6, wherein the third contact partner is sleeve-shaped or pin-shaped.

19. The stator according to claim 9, wherein the additional element is a spring element or a crimping element.

20. The stator according to claim 12, wherein the twisted stator discs (7) are fixed in the stator body (3) by welding the twisted stator discs (7) with adjacent stator discs (7) or by a press fit between the stator body (3) and a stator housing.
